(19) United States
(12) Patent Application Publication
(10) Pub. No.: US 2018/0112864 A1
(43) Pub. Date: Apr. 26, 2018

(54) MOUSE

(71) Applicant: ALSON TECHNOLOGY LIMITED, KOWLOON (HK)

(72) Inventors: Han-Hung CHENG, Zhubei City (TW); Chi-Fen KUO, Zhubei City (TW)

(21) Appl. No.: 15/333,640

(22) Filed: Oct. 25, 2016

(51) Int. Cl. F21V 33/00; G06F 3/0354; G06F 1/32; F21V 3/00; F21V 23/06; H05B 41/36

(52) U.S. Cl. CPC F21V 33/0052; G06F 3/03543; H05B 41/36; F21V 3/00; F21V 23/06; G06F 1/3259

(57) ABSTRACT

A mouse is provided, including a mouse module and a light-emitting module. The mouse module has a light-penetrable portion and a mouse base. The light-emitting module is disposed on the mouse base. The light-emitting module includes a substrate, a boost circuit and a plasma tube. The plasma tube has a light-emitting main body and two electrodes. At least part of the light-emitting main body corresponds to the light-penetrable portion.

### BACKGROUND OF THE INVENTION

### Field of the Invention

The present invention relates to a mouse.

### Description of the Prior Art

Computers or the like are generally designed for users to get well with them. Mouse is an important peripheral inputting component. User can uses the mouse to select what he/her wants such as folds or files on the screen directly. This type of mouse is disclosed in TWI413917, for example.

However, the conventional mouse is just a component used to select wanted folds or files on the screen but not accompanied with additional useful functions. This conventional mouse, now, cannot satisfy users any more, with nothing but inputting function and sensitivity of the mouse.

The present invention has arisen to mitigate and/or obviate the afore-described disadvantages.

### SUMMARY OF THE INVENTION

The major object of the present invention is to provide a mouse, which can emit light for guiding user to find the mouse quickly in a dark environment. In addition, the user's eyes do not feel uncomfortable. It does not need to undergo light-guiding or light-softening processes, and the structure is simple.

To achieve the above and other objects, a mouse is provided, including: a mouse module, having a light-penetrable portion and a mouse body, the light-penetrable portion being arranged on the mouse body, the mouse body having a base, a cover and a circuit board, the cover covering the base, the cover and the base defining an interior space, the circuit board for being electrically connected to a first power source and disposed in the interior space; a light-emitting module, attached to the mouse body, including a substrate, a boost circuit and a plasma tube, the boost circuit disposed on the substrate, the boost circuit including at least one conductive line and a plurality of electronic components, the electronic components being electrically connected to the at least one conductive line, the at least one conductive line including a power input portion and two power output portions, the power input portion for being electrically connected to a second power source, the plasma tube having a light-emitting main body and two electrodes, the light-emitting main body at least partly corresponding to the light-penetrable portion, the two electrodes being connected to the light-emitting main body and respectively electrically connected to the two power output portions.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIGS. 1 and 2 are stereograms of an embodiment of the present invention;

FIGS. 3 and 4 are respective cross-sectional side views of FIGS. 1 and 2;

FIG. 5 is a diagram showing a relation of a triggering switch of an embodiment of the present invention;

FIG. 6 is a diagram showing a relation of a light-emitting module of the embodiment of the present invention;

FIG. 7 is a cross-sectional side view of another embodiment of the present invention;

FIG. 8 is a stereogram of still another embodiment of the present invention;

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

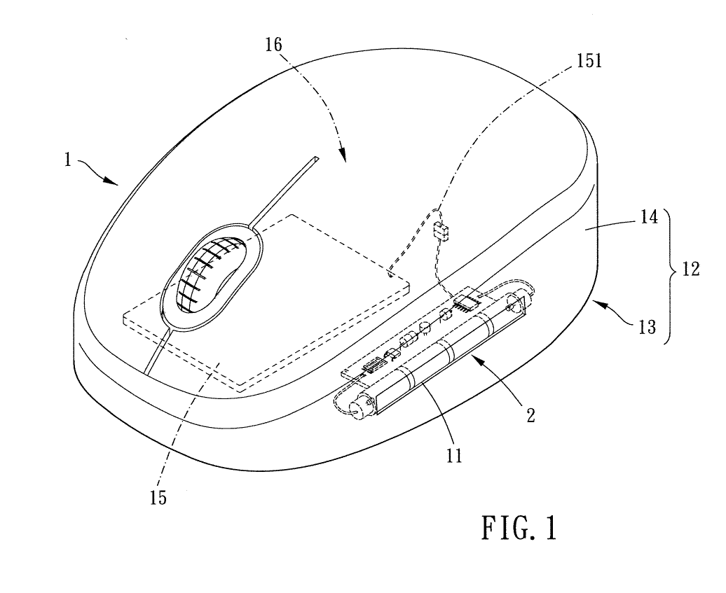

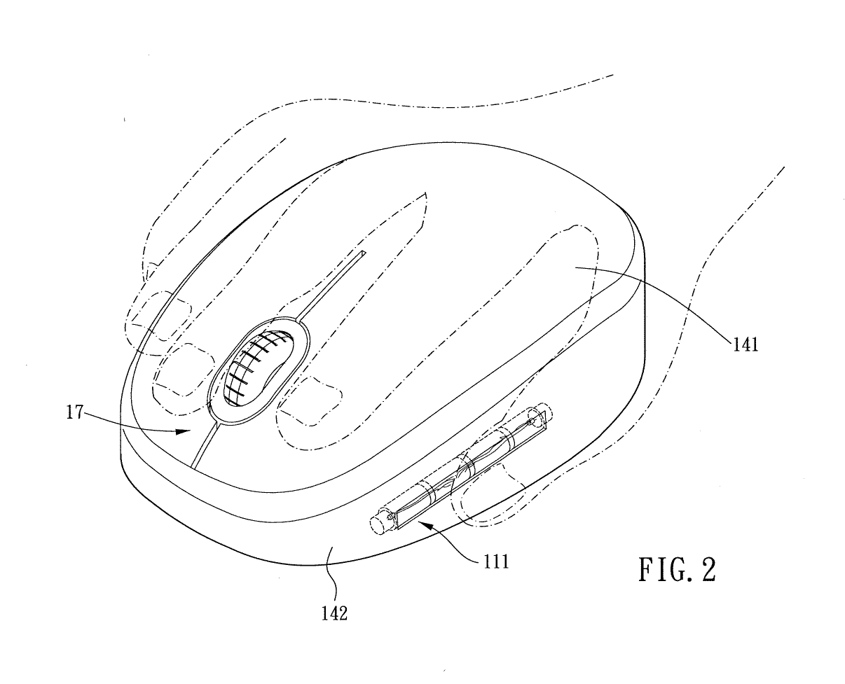

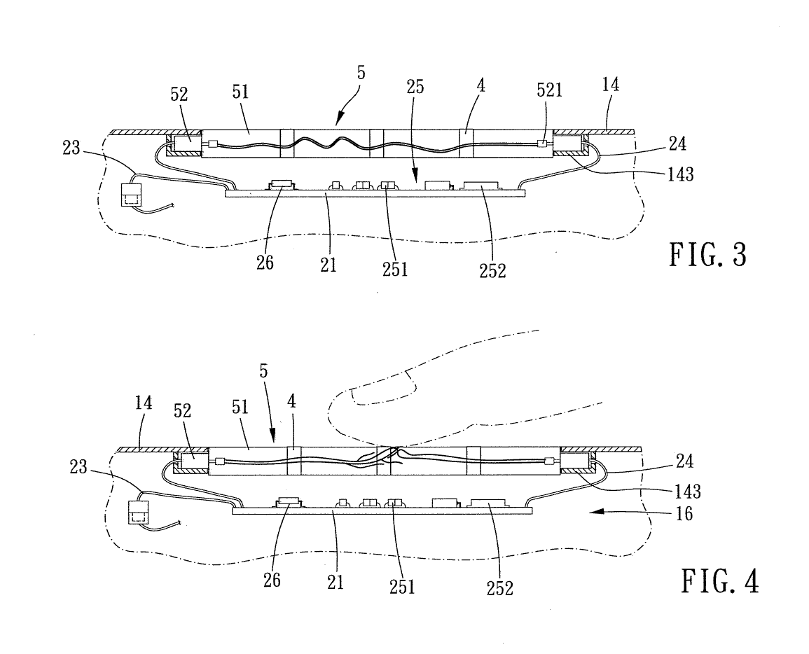

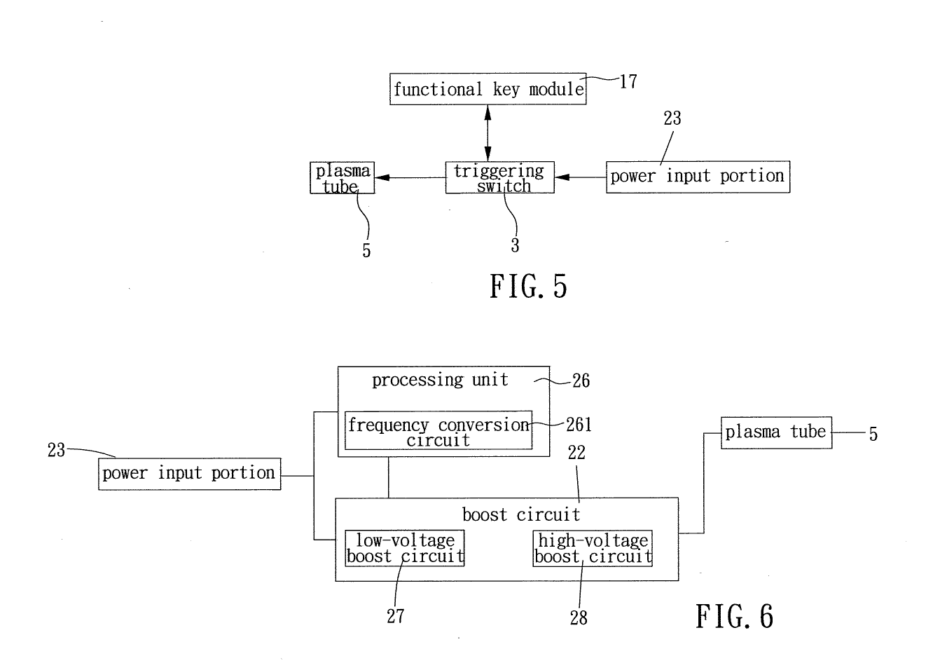

Please refer to FIGS. 1 to 6 for an embodiment of the present invention. A mouse includes a mouse module 1 and a light-emitting module 2.

The mouse module 1 has a light-penetrable portion 11 and a mouse body 12, the light-penetrable portion 11 is arranged on the mouse body 12, the mouse body 12 has a base 13, a cover 14 and a circuit board 15, the cover 14 covers the base 13, the cover 14 and the base 13 define an interior space 16, and the circuit board 15 is for being electrically connected to a first power source and disposed in the interior space 16. The light-emitting module 2 is attached to the mouse body 12 and includes a substrate 21, a boost circuit 22 and a plasma tube 5, the boost circuit 22 is disposed on the substrate 21, the boost circuit 22 includes at least one conductive line and a plurality of electronic components 25, the electronic components 25 are electrically connected to the at least one conductive line, the at least one conductive line includes a power input portion 23 and two power output portions 24, the power input portion 23 is for being electrically connected to a second power source, the plasma tube 5 has a light-emitting main body 51 and two electrodes 52, the light-emitting main body 51 at least partly corresponds to the light-penetrable portion 11, and the two electrodes 52 are connected to the light-emitting main body 51 and respectively electrically connected to the two power output portions 24.

Specifically, the conductive line is buried in the substrate 21, and the substrate 21 and the conductive lines define a printing circuit board; and of course, the conductive lines may be arranged on the substrate 21 in other ways. The boost circuit 22 transfers a low-voltage direct current which is input by the power input portion 23 to a high-voltage alternating current and supplies the high-voltage alternating current through the two power output portions 24 to the plasma tube 5. The boost circuit 22 may transfer the low-voltage direct current into a light-voltage pulsed direct current.

More specifically, the circuit board 15 has a power supply end 151, and the power input portion 23 is electrically connected to the power supply end 151. In other words, in this embodiment, the first and second power sources are the same, the first power source provides power through the circuit board 15 to the light-emitting module 2. In other embodiments, the first and second power sources may be independently separated from each other. In addition, the two electrodes 52 are disposed on two opposite ends of the light-emitting main body 51, the light-emitting main body 51 and the two electrodes 52 are coaxially arranged, and the light-emitting main body 51 is greater than each said electrode 52 in radial dimension. Each said electrode 52 includes an electrode cap 521 which is located within the light-emitting main body 51 and is hollow, and the two electrode caps 63 are substantially coaxially arranged so that light can be emitted from a periphery of the electrode caps 63 and distributed evenly.

More specifically, the light-emitting module 2 further includes a processing unit 26 which is disposed on the substrate 21, the processing unit 26 includes an frequency conversion circuit 261 which is electrically connected to the power input portion 23 and the boost circuit 22, the frequency conversion circuit 261 is configured to transfer an input power source which has a first frequency from the power input portion 23 to at least one output power source which has a second frequency and an output power source which has a third frequency, the at least one output power source having the second frequency and the output power source having the third frequency are transmitted to the boost circuit 22 in a preset sequence, the first frequency and the second frequency are different, and the second frequency and the third frequency are different; therefore, the plasma tube 5 produces the light which waves variously based on the power sources having different frequencies input by the boost circuit 22.

The plurality of electronic components 25 include a plurality of passive components 251 and at least one transformer 252, and the plurality of passive components 251 are electrically connected to one another to form a low-voltage boost circuit 27 which is electrically connected to the power input portion 23 and the processing unit 26 so as to boost the power source provided by the circuit board 15, for example, from 1.5-3.5V to 12-15V The at least one transformer 252 forms a high-voltage boost circuit 28 which is electrically connected between the low-voltage boost circuit 27 and the two power output portions 24 so as to transfer a low-voltage power to a high-voltage power, for example, from 12-15V to 700-900V, for the plasma tube 5 to use.

In this embodiment, the light-emitting module 2 is disposed in the interior space 16, the cover 14 has the light-penetrable portion 11, the light-penetrable portion 11 is a through hole 111, and the light-emitting main body 51 is exposed from the through hole 111 and non-protrusive beyond the cover 14. Therefore, the light emitted by the light-emitting main body 51 can light up surroundings of the mouse so that the user can see objects clearly in an environment where light is weak, and the user's eyes will not feel uncomfortable. It is to be noted that when a finger of a human body touches the light-emitting main body 51, the light in the light-emitting main body 51 undergoes electronic neutralization (when the human body functions as a grounding wire), a part of the light is guided to a place that the finger touches so as to produce outstanding light paths, and the through hole 111 allows the user to directly touch the light-emitting main body 51 conveniently to produce the above-mentioned effect.

It is to be noted that with the design that the light-emitting main body 51 does not protrude beyond the cover 14, the light-emitting main body 51 can be effectively prevented from being impacted unexpectedly so as to protect a structural integrity of the light-emitting main body 51. Preferably, the cover 14 further has a positioning portion 143 which is positioned on the plasma tube 5 so as to prevent the plasma tube 5 from moving relative to the cover 14 to avoid impacts. Preferably, in an opening direction of the through hole 111, the cover 14 covers the two electrodes 52 completely so as to prevent the user from touching the electrode 52 and experiencing an electric shock and to block objects from attaching on each said electrode 52. More preferably, the light-emitting module 2 further includes at least one protecting member 4, and each said protecting member 4 covers at least a part of the light-emitting main body 51 so as to prevent objects from impacting the light-emitting main body 51 and to absorb or disperse the impact to protect the light-emitting main body 51. Specifically, each said protecting member 4 is preferably made of a transparent material so as to provide a preferable light-penetrating effect.

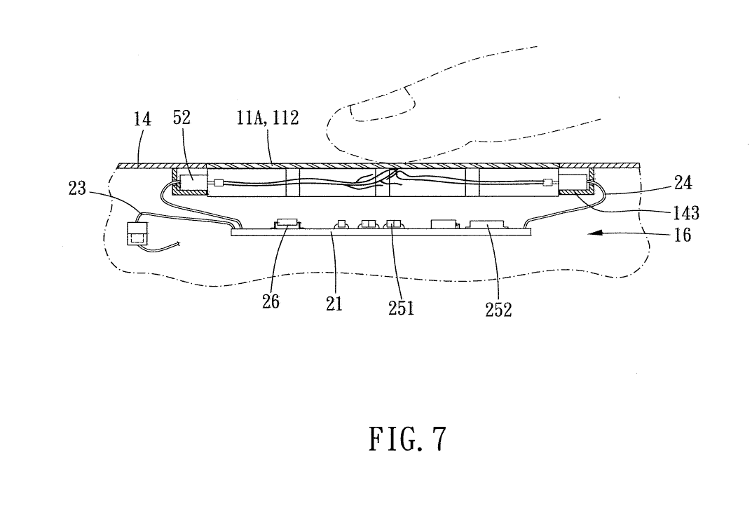

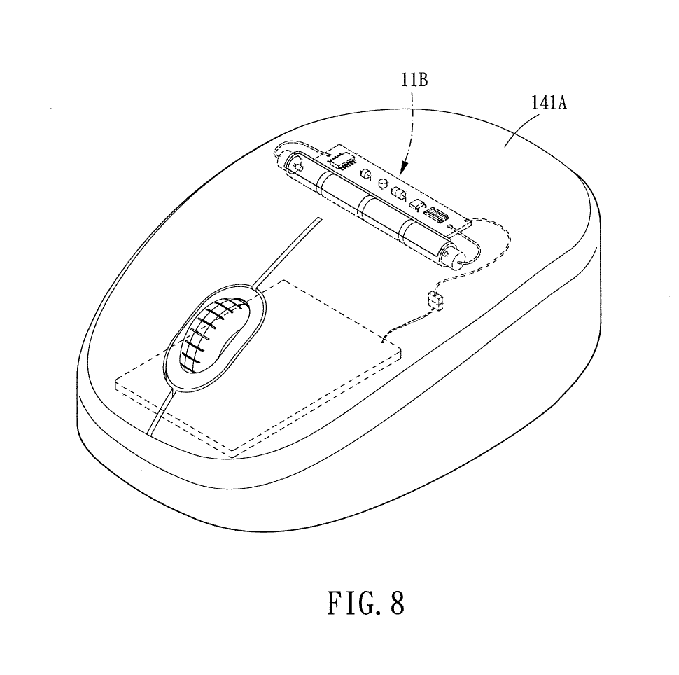

It is understandable that the light-penetrable portion 11 may be in other types. Please refer to FIG. 7 for another embodiment, a light-penetrable portion 11A is a cover board 112 which is made of a transparent material, and the light-emitting module 2 is disposed in the interior space 16 and located between the light-penetrable portion 11A and the base 13 so that the cover board 112 can protect the light-emitting main body 51 thoroughly. Preferably, the light-emitting main body 51 is disposed near the cover board 112 to prevent the cover board 112 from influencing outstanding effect which human body triggers and guides the light, for example, the light-emitting main body 51 contacts the cover board 112 tightly. It is understandable that in other embodiments, the cover board may be a part of the cover, and in other words, the whole cover may be made of the transparent material. Please refer to FIGS. 1 to 6 again, the cover 14 further includes a main region 141 and a secondary region 142 connected with the main region 141, the main region 141 is configured for contact of a palm of a hand, the secondary region 142 is configured for contact of at least one finger of the hand, and the light-penetrable portion 11 is disposed in the secondary region 142. In another embodiment as shown in FIG. 8, a light-penetrable portion 11B may be disposed in the main region 141.

The mouse module 1 further has at least one functional key module 17 (such as left and right buttons, and rolling wheel). Each said functional key module 17 is for operation to be optionally electrically connected to the circuit board 15. The light-emitting module 2 further has a triggering switch 3, the triggering switch optionally electrically connects the power input portion 23 and the plasma tube 5, the triggering switch 3 is configured to detect a state of electrical connection of each said functional key module 17 and the circuit board 15. When one said functional key module 17 is electrically connected with the circuit board 15, the triggering switch 3 electrically connects the power input portion 23 and the plasma tube 5; otherwise, the power input portion 23 and the plasma tube 5 are not electrically connected. As the at least one functional key module 17 is pressed, intermittent lighting is carried out. It is understandable that the embodiments mentioned above may cooperate with each other to develop various modes.

Given the above, the mouse can light up for guiding user to find the mouse quickly in a dark environment. In addition, the user's eyes do not feel uncomfortable. It does not need to undergo light-guiding or light-softening processes, and the structure is simple. Besides, the cover covers the electrode to protect the user from experiencing electronic shock, the plasma tube does not protrude beyond the through hole to lower a change that the plasma tube is touched, and the light-emitting main body is covered by the protecting member to elevate an anti-collision ability.

While we have shown and described various embodiments in accordance with the present invention, it should be clear to those skilled in the art that further embodiments may be made without departing from the scope of the present invention.

1. A mouse, including:
a mouse module, having a light-penetrable portion and a mouse body, the light-penetrable portion being arranged on the mouse body, the mouse body having a base, a cover and a circuit board, the cover covering the base, the cover and the base defining an interior space, the circuit board for being electrically connected to a first power source and disposed in the interior space;
a light-emitting module, attached to the mouse body, including a substrate, a boost circuit and a plasma tube, the boost circuit disposed on the substrate, the boost circuit including at least one conductive line and a plurality of electronic components, the electronic components being electrically connected to the at least one conductive line, the at least one conductive line including a power input portion and two power output portions, the power input portion for being electrically connected to a second power source, the plasma tube having a light-emitting main body and two electrodes, the light-emitting main body at least partly corresponding to the light-penetrable portion, the two electrodes being connected to the light-emitting main body and respectively electrically connected to the two power output portions;
wherein the mouse module further has at least one functional key module, each said functional key module is for operation to be optionally electrically connected to the circuit board, the light-emitting module further has a triggering switch, the triggering switch optionally electrically connects the power input portion and the plasma tube, the triggering switch is configured to detect a state of electrical connection of each said functional key module and the circuit board; when one said functional key module is electrically connected with the circuit board, the triggering switch electrically connects the power input portion and the plasma tube, otherwise the power input portion and the plasma tube are not electrically connected.

2. The mouse of claim 1, wherein the light-emitting module is disposed in the interior space, the cover has the light-penetrable portion, the light-penetrable portion is a through hole, the light-emitting main body is exposed from the through hole and non-protrusive beyond the cover, and in an opening direction of the through hole, the cover covers the two electrodes completely.

3. The mouse of claim 1, wherein the cover has the light-penetrable portion, the light-penetrable portion is a cover board made of a light-penetrable material, the light-emitting module is disposed in the interior space and located between the light-penetrable portion and the base, and the light-emitting main body is near the light-penetrable portion.

4. (canceled)

5. The mouse of claim 1, wherein the light-emitting module further includes at least one protecting member, and each said protecting member covers at least a part of the light-emitting main body.

6. A mouse, including:
a mouse module, having a light-penetrable portion and a mouse body, the light-penetrable portion being arranged on the mouse body, the mouse body having a base, a cover and a circuit board, the cover covering the base, the cover and the base defining an interior space, the circuit board for being electrically connected to a first power source and disposed in the interior space;
a light-emitting module, attached to the mouse body, including a substrate, a boost circuit and a plasma tube, the boost circuit disposed on the substrate, the boost circuit including at least one conductive line and a plurality of electronic components, the electronic components being electrically connected to the at least one conductive line, the at least one conductive line including a power input portion and two power output portions, the power input portion for being electrically connected to a second power source, the plasma tube having a light-emitting main body and two electrodes, the light-emitting main body at least partly corresponding to the light-penetrable portion, the two electrodes being connected to the light-emitting main body and respectively electrically connected to the two power output portions;
wherein the light-emitting module further includes a processing unit which is disposed on the substrate, the processing unit includes a frequency conversion circuit which is electrically connected to the power input portion and the boost circuit, the frequency conversion circuit is configured to transfer an input power source which has a first frequency from the power input portion to at least one output power source which has a second frequency and an output power source which has a third frequency, the at least one output power source having the second frequency and the output power source having the third frequency are transmitted to the boost circuit in a preset sequence, the first frequency and the second frequency are different, and the second frequency and the third frequency are different.

7. The mouse of claim 6, wherein the plurality of electronic components include a plurality of passive components and at least one transformer, the plurality of passive components are electrically connected to one another to form a low-voltage boost circuit which is electrically connected to the power input portion and the processing unit, and the at least one transformer forms a high-voltage boost circuit which is electrically connected between the low-voltage boost circuit and the two power output ends.

8. The mouse of claim 7, wherein the light-emitting module is disposed in the interior space, the cover has the light-penetrable portion, the light-penetrable portion is a through hole, the light-emitting main body is exposed from the through hole and non-protrusive beyond the cover, and in an opening direction of the through hole, the cover covers the two electrodes completely; the mouse module further has at least one functional key module, each said functional key module is for operation to be optionally electrically connected to the circuit board, the light-emitting module further has a triggering switch, the triggering switch optionally electrically connects the power input portion and the plasma tube, the triggering switch is configured to detect a state of electrical connection of each said functional key module and the circuit board; when one said functional key module is electrically connected with the circuit board, the triggering switch electrically connects the power input portion and the plasma tube, otherwise the power input portion and the plasma tube are not electrically connected; the light-emitting module further includes at least one protecting member, and each said protecting member covers at least a part of the light-emitting main body; the circuit board has a power supply end, and the power input portion is electrically connected to the power supply end; the cover further includes a positioning portion with which the plasma tube is positioned; the two electrodes are disposed respectively at opposite ends of the light-emitting main body, and the light-emitting main body and the two electrodes are coaxially arranged; each said electrode includes an electrode cap which is located within the light-emitting main body and is hollow, and the two electrode caps are substantially coaxially arranged; the cover further includes a main region and a secondary region connected with the main region, the main region is configured for contact of a palm of a hand, the secondary region is configured for contact of at least one finger of the hand, and the light-penetrable portion is disposed in the secondary region.
